(19) United States
(12) Patent Application Publication
(10) Pub. No.: US 2014/0373748 A1
(43) Pub. Date: Dec. 25, 2014

(54) METHOD FOR PRODUCING MILK PROTEIN GELS, -HYDROGELS, -HYDROCOLLOIDES AND -SUPERABSORBERS (MILK PROTEIN GELS)

(71) Applicant: Qmilch IP GmbH, Hannover (DE)

(72) Inventor: Anke Domaske, Hannover (DE)

(73) Assignee: QMILCH IP GMBH, Hannover (DE)

(21) Appl. No.: 14/357,255

(22) PCT Filed: Nov. 12, 2012
(86) PCT No.: PCT/EP2012/072420

§ 371 Date: Aug. 28, 2014

(30) Foreign Application Priority Data
Nov. 12, 2011 (DE) 102011118399.3

(51) Int. Cl. C09D 189/00

(52) U.S. Cl. CPC C09D 189/00; C08K 5/05
USPC 106/135.1; 435/68.1; 106/156.1

(57) ABSTRACT

The disclosure relates to a milk protein hydrol gel, in which at least one protein which is obtained from milk and which can be thermally plasticized, is plasticized using a plasticizing agent, such as for example, water or glycerol at temperatures between room temperature and preferably up to 140° C. by means of mechanical stress and subsequently retreated according to a continuous or discontinuous process to form hydrogels.

### CROSS-REFERENCE TO RELATED APPLICATIONS

This application is a National Stage of International Application No. PCT/EP2012/072420, filed on Nov. 12, 2012, and published in German as WO 2013/068595 A1 on May 16, 2013. This application claims the benefit and priority of German Application No. 10 2011 118 399.3, filed on Nov. 12, 2011. The entire disclosures of the above applications are incorporated herein by reference.

### BACKGROUND

This section provides background information related to the present disclosure which is not necessarily prior art.

### TECHNICAL FIELD

Methods for producing polymeric hydrogels are described in literature and known to the man skilled in the art. Within the scope of the present application this hydrogel group also comprises milk protein bearing gels, aqueous gels, hydrogels, hydrocolloides and superabsorbers.

### DISCUSSION

A hydrogel is a water containing, but water-insoluble polymer, the molecules of which are chemically and physically cross-linked to form a three-dimensional network. Due to integrated hydrophile polymer components, they swell in water while their volume considerably increases, but without losing their substantial cohesion.

Physical interactions between the polymers or the three-dimensional cross-linking of these polymers enable to form a gel. Polymer based hydrogels can also be cross-linked to form a three-dimensional matrix by means of covalent addition of bifunctional agents to the proteins and thus they can form a corresponding gel.

For producing hydrogels and superabsorbers, 2-hydroxyethylmethacrylate which is designated as HEMA, poly(ethylene glycol) and poly(ethylene oxide) which are designated as PEG or PEO have been used so far. HEMA, PEG and PEO polymers are advantageous for producing biomatrices since they are pH and temperature resistant.

E. M. D'urso and G. Fortier produced hydrogels which were formed by combining bovine serum albumin (BSA) and PEG in alkaline solution. Protein molecules serve as anchoring points and are cross-linked to each other by using bi-functionalized PEG.

The U.S. Pat. No. 5,514,379 (Weissleder et. Al.) teaches the synthesis of biocompatible, biodegradable hydrogels using proteins or polysaccharides with cross linking agents, such as polyvalent derivates of polyethylene or polyalkylene glycol. More especially, the cross linking agents are selected from the following group: bishydroxysuccinimide ester of polyalkylene glycol (“PAG”) diacid, bishydroxysulfosuccinimide ester of PAG diacid, bisimidate of PAG diacid, bisimidazolide of PAG diacid, bisimidazolide of PAG, bishalogenide of PAG, bischloranydride of PAG diacid, bis-(n-aminoalkyl) of PAG and bis-(polyoxyalkylene-bis- or bisbenzoxazolide of PAG). The reaction between the cross linking agent and a protein such as BSA takes place in DMSO solution.

The U.S. Pat. No. 5,733,563 (Fortier) explains the production of bio-artificial hydrogels that takes place in alkaline solution and that comprises a three-dimensional cross linked mixture of bi-functionalized polyethylene oxide with a protein of the albumin type. The bi-functionalized polyethylene oxide is preferably polyethylene glycol and the protein of the albumin type is selected from different sources, such as BSA (bovine serum albumin), lactalbumin and ovalbumin. The patent comprises a method for producing the hydrogels, the description of the hydrogels and different applications of the hydrogels.

The physical properties of hydrogels have led to a number of uses of these ones, including as implant materials, contact lenses and wound bandages and as carrier for the controlled release of medications.

The production according to the described methods has been uneconomical so far, since one condition was a long reaction time. Mass productions were thus not useful.

The used buffer systems (such as phosphate or borate buffers) allowed a controlled cross linking reaction, but the constant pH value inhibited the variations which could be generated by different raw materials. Furthermore, the cross linking reactions were inhibited, which caused long reaction times and thus led to an uneconomic production.

More recent patent specifications tried to describe quicker and more efficient methods. EP 1 280 849 (Bioartificial Gel Technologies Inc.) inter alia teaches a production and a qualitative characterization of PEG casein hydrogel formulations. It is however disadvantageous that PEG belongs to the allergens. Additionally, PEG derivates connect water to fats and are used for cleaning or softening the skin. Since they make the skin more permeable, the active substances shall be enabled to penetrate in an easier way. But many PEG derivates contain carcinogenic impurities and, apart from the desired active substances, also substances such as for example preservatives which are suspected to be carcinogens and allergy substances get thus into our skin. For producing PEG and PEG derivates, ethylene oxide is used, wherein water, monoethylene glycol or diethylene glycol can be used as starting molecules. After having obtained the desired molecule mass, the reaction is stopped by adding an acid (e.g. lactic acid). Ethylene oxide is a highly reactive substance and a potential carcinogen. An industrial production is neither described. Furthermore, the pre-mixture has to be kept warm for 24 hours before the further processing can start. Thus, a method results from this which is not economic. Besides, the hydrogels present weak mechanical properties.

The U.S. Pat. No. 3,639,524 (Seiderman) presents a production of cross linked hydrogel polymers by means of (1) N-vinyl-2-pyrrolidone, (2) alkyl methacrylate. In the synthesis of NMP, γ-butyrolactone, which has been previously generated in a catalytic way from formaldehyde and acetylene via several intermediate stages, is reacted with methylamine. NMP is considered toxic, harmful to health and irritating. The polymerization also needs several hours such that no economic result can be obtained.

The German Patent (PCT/EP2002/000825) describes the production of synthetic hydrogels on the base of poly (meth) acrylic acids, poly (meth) acrylates, poly (meth) acrylamides, polyurethanes, polyvinyl pyrrolidones, polyvinyl alcohols, polyvinyl acetates or the copolymers and derivates thereof as well as mixtures of these ones. Hydrogels can be based upon natural polymers, wherein the natural polymer can be selected from the group of polysaccharides such as optionally modified starch, starch derivates, dextrines, agaroses, agar-agar, curdlane, alginic acid and alginates, chitosans, polypeptides such as gelatin, pektines and pektinates, caraeenanes as well as celluloses and cellulose derivates such as carboxymethyl cellulose, cellulose acetate, cellulose acetate butyrate and alkyl celluloses as well as mixtures thereof. Protein based hydrogels are however not mentioned. Methacrylic acids are industrially obtained from petroleum synthesis.

The U.S. patent Ser. No. 10/801,232 (Plochocka) describes the production of a hydrogel by means of a polymer and an extruder, wherein maleic acid anhydride is mentioned as an important teaching of the present disclosure. Maleic acid anhydride is obtained from partial oxidation of n-butane or the so called “raffinate II” by means of a vanadium-phosphorous-oxide (VPO) catalyst. [4] The “raffinate II” is a part of the C4 fraction which is generated during the steam cracking and essentially consists of the isomers n-butene and n-butane. It is thus again a petroleum based product. Furthermore, it presents a health risk and is an irritating substance. On big technical scale, maleic acid is produced from maleic acid anhydride; the anhydride is in turn synthesized by catalytic oxidation of benzene or butane. Furthermore, ethoxylated amines, amino alcohols, amides and imides are used as cross linking agents. Imide groups are obtained from the reaction with ammonia. Amides are also chemical compounds which formally derive from ammonia. Ethoxyl amines are reactions with ethyl oxide. Ethoxylation is the adhesion of ethylene oxide (oxirane) to compounds such as for example alcohols, phenols, amines or carbonic acids. Additionally, analkylvinyl ether; methylvinyl ether, isobutylvinyl ether, polyvinyl alcohol, olefin, ethylenes, butylenes, isobutylenes and ethoxylated/propoxylated derivates are also mentioned. It is additionally described that the polymer which is cross linked in the extrusion process is an ester or an amide or an imide. Milk proteins do not belong to any of these definitions.

Carboxyl modified, super-absorbing, protein containing hydrogel, EP 1 263 883 (Damodaran) includes a production by means of glutaraldehyde. It is over all highly toxic for water organisms and causes serious irritations of the eyes, the nose, the throat and the lungs which are accompanied by headache, drowsiness and dizziness. Additionally, a fish protein is preferably used. The industrial production is not described. The hardening over night is industrially uneconomic.

In spite of these known methods it has not been possible so far to give polymeric hydrogels made of renewable raw materials (over all protein based) an economic efficiency which is required for an industrial usability, without addition of acrylates and fossil raw materials. The use of acrylates and fossil raw materials should be, if possible, largely avoided for reasons of health.

### SUMMARY

It is an object of the invention to eliminate the above mentioned disadvantages and to give hydrogels, made of renewable raw materials (preferably protein based), a required water or humidity resistance, preferably without addition of acrylates and fossil raw materials.

Herein, the invention shall in particular reduce the processing time and the use of chemicals and preferably, and to the greatest possible extend, produce the hydrogels from renewable and biodegradable raw materials. Simultaneously, the water and energy consumption shall be decreased and the productivity be increased.

The aim is achieved by a method according to the teachings of the present disclosure.

The present invention aims at hydrogels which are produced by a continuous or discontinuous process with a composition which preferably comprises destructured milk proteins, biodegradable thermoplastic polymers and softening agents.

Herein, at least one protein obtained from milk or alternatively also a protein produced from bacteria is plasticized, optionally together with a plasticizer, at temperatures comprised between room temperature and preferably up to 140° C. under mechanical stress.

The invention is based upon the knowledge that the milk proteins and in particular casein and the derivates thereof can be plasticized and in this manner be polymerized. It is provided that the plasticizing takes place at temperatures of preferably up to 140° C.

For achieving an even more gentle treatment, the protein is intensely mixed or kneaded with a plasticizer and simultaneously subjected to mechanical stress. Herein, the temperature which is required for the plasticizing is considerably reduced by means of the plasticizer.

The milk protein is preferably casein or lactalbumin or soy protein.

The protein obtained from milk can be produced in situ by precipitation from milk. According to a first procedure, the milk in form of a mixture with lab, other suitable enzymes or acid can be immediately introduced into the process as flocculated mixture or the pressed-off flocculated protein can be used in humid form. According to another optional procedure, a previously separately obtained, if necessary prepared, pure or mixed protein, i.e. a protein fraction from milk, can be used, for example in the form of a dried powder.

The protein fraction can also be produced by ultrafiltration or by using cell cultures. Furthermore, the milk proteins can be modified in other process steps for example by additional salts such as sodium and potassium, such that a casein is produced.

The milk protein used according to the invention can be mixed with other proteins in a proportion of preferably up to 70% by mass with respect to the milk protein. For this, other albumins, such as ovalbumin and vegetable proteins, in particular lupine protein, soy protein or wheat proteins, in particular gluten can be used.

The mixture of solvent and protein is heated up, usually under pressure conditions and shear, in order to accelerate the cross linking process. Chemical and enzymatic agents can also be used, in order to destructurize and to cross link, to oxidize and to derivatize, to etherify, to saponify and to esterify the milk proteins. Usually, the milk proteins are destructurized by dissolving them in water. The milk proteins are completely destructurized, if there are no clots which influence the polymerizing.

In the present invention, a plasticizer can be used in order to destructurize the milk proteins and to enable the milk proteins to flow, i.e. to produce thermoplastic milk proteins. The same plasticizer or other plasticizers can be used in order to increase the melting proccessability, or two separate plasticizers can be used. The plasticizers can also improve the flexibility of the final products, wherein it is assumed that this is due to the reduction of the glass transition temperature of the composition caused by the plasticizer. The plasticizers are essentially compatible with the polymer constituents of the present invention, such that the plasticizers can effectively modify the properties of the composition. As it is used here, the expression “essentially compatible” means that if the plasticizer is heated up to a higher temperature than the softening and/or melting temperature of the composition, the plasticizer will be able to form an essentially homogenous mixture with milk proteins.

The plasticizer is preferably water which is used in a proportion comprised between 20 and 80% with regard to the weight of the protein, preferably in a proportion comprised between approximately 40 and 50% by mass of the protein content.

Instead of water or mixed with this one, other plasticizers, in particular alcohols, poly alcohols, carbohydrates in aqueous solution and in particular aqueous polysaccharide solutions can be used.

In detail, the following plasticizers and associated proportions are preferred:—hydrogen bridges forming organic compounds without hydroxyl group, for example urea—and derivates,—animal proteins, e.g. gelatin,—vegetable proteins such as for example cotton,—soy beans,—and sunflower proteins,—esters of producing acids which are biodegradable, e.g. citric acid, adipic acid, stearic acid, oleic acid,—hydrocarbon-based acids, e.g. ethylene acrylic acid, ethylene maleic acid, butadiene acrylic acid, butadiene maleic acid, propylene acrylic acid, propylene maleic acid,—sugars, for example maltose, lactose, sucrose, fructose, maltodextrose, glycerin, pentaerythrit and sugar alcohols, e.g. malitol, mannitol, sorbitol, xylitol,—polyols, e.g. hexanetriol, glycols and the like, also mixtures and polymers,—sugar hydrides, e.g. sorbitan,—esters, such as for example glycerin acetate, (mono, -di, -triacetate) dimethyl and diethylsuccinate and related esters, glycerin propionates, (mono, -di, -tripropionate) butanoates, stereates, phthalate esters. These are non limiting examples of hydroxyl softening agents. Important influencing factors are the affinity to the proteins, the quantity of proteins and the molecular weight. Glycerin and sugar alcohols belong to the most important softening agents. The percentages of the softening agents are for example comprised between 5% and 55%, but they can also be comprised between 2% and 75%. Any desired alcohols, polyols, esters and polyesters can be preferably used in a percentage of up to 30% by weight in the polymer mixture.

The rheological features are of a particular importance for the milk protein gel mixture, in order to achieve a good processing. The solidification under stretch flow is required for forming a stable polymer structure. The melting temperature is mostly in a temperature range comprised between 30° C. and 190° C. Temperatures above these values should be reduced by means of diluents and softening agents.

The biodegradability of the hydrogels, i.e. their decomposition by living creatures and their enzymes is an important feature of the milk protein gels.

These compounds are for example and preferably suitable as biodegradable thermoplastic polymer of this invention: polyvinyl alcohol and polyvinyl copolymers, aliphatic amide and ester copolymers which are formed by monomers such as for example dialcohols (1,4-butandiol, 1,3-propandiol, 1,6-hexandiol etc.) or ethylene glycol and diethylene glycol, aliphatic polyesteramides, (aliphatic esters are formed with aliphatic amides) or by means of other reactions, such as for example lactic acid with diamines and dicarbonic acid dichlorides, dioles with carbonic acids, caprolacton and caprolactam, or ester prepolymers with diisocyanates, dicarbonic acids, especially succinic acid, oxalic acid and adipic acid and the esters thereof, hydroxycarbonic acids, lactones, amino alcohols (for example ethanolamine, propanolamine), cyclic lactams, aminocarbonic acids (e.g. aminocaproic acid), dicarbonic acids and diamines (e.g. salt mixtures of dicarbonic acids) and mixtures thereof. Polyesters such as for example oligoesters can also be used.

Polybutylene succinate/adipate copolymer; polyalkylene succinates; polypentamethyl succinates; polyhexamethyl succinates; polyheptamethyl succinates; polyoctamethyl succinates; polyalkylene oxalates, such as polyethylene oxalate and polybutylene oxalate, polyalkylene succinate copolymers, such as polyethylene succinate/adiapte copolymer and polyalkylene oxalate copolymers, such as polybutylene oxalate/succinate copolymer and polybutylene oxalate/adipate copolymer; polybutylene oxalate/succinate/adipate terpolymers; and mixtures thereof are non limiting examples of aliphatic polyesters of dibasic acids/dioles which are for example produced by polymerization of acids and alcohols or ring-opening reactions and are suitable for producing a polymeric hydrogel.

In the production of biodegradable polymeric hydrogels, aliphatic/aromatic copolyesters can also be used. These copolyesters are formed in a condensation reaction from dicarbonic acids (and derivates) such as malonic, succinic, glutaric, adipic, pimelic, azelaic, sebacic, fumaric, 2,2-dimethyl glutaric, suberic, 1,3-cyclopentane dicarbonic, 1,4-cyclohexane dicarbonic, 1,3 cyclohexane dicarbonic, diglycolic, itaconic, maleic, 2,5-norbomandicarbonic, 1,4-terephtalic, 1,3-terephtalic, 2,6-naphtoeic , 1,5 naphtoeic acid, esters forming derivates and mixtures thereof and dioles, for example ethylene glycol, diethylene glycol, triethylene glycol, tetraethylene glycol, propylene glycol, 1,3-propane diole, 2,2 dimethyl-1,3-propane diole, 1,3-butane diole, 1,4-butane diole, 1,5-pentane diole, 1,6-hexane diole, 2,2,4-trimethyl-1,6-hexane diole, thiodiethanol, 1,3-cyclohexane dimethanol, 1,4-cyclohexane dimethanol, 2,2,4,4-tetramethyl-1,3-cyclobutane diole and combinations thereof. Examples of such aliphatic/aromatic copolyesters include mixtures of poly(tetramethylene glutarate-co-terephthalate), poly(tetramethylene glutarate-co-terephthalate), poly(tetramethylene glutarate-co-terephthalate), poly(tetramethylene glutarate-co-terephthalate), poly(tetramethylene glutarate-co-terephthalate-co-diglycolate), poly(ethyleneglutarate-co-terephthalate), poly(tetramethyleneadipate-co-terephthalate), a mixture having a ratio of 85/15 of poly(tetramethylenesuccinate-co-terephthalate), poly(tetramethylene-co-ethylene-glutarate-co-terephthalate), poly(tetramethylene-co-ethyleneglutarate-co terephthalate).

The proccessability of the protein mass can be modified by other materials, in order to influence the physical and mechanical properties of the protein mass, but also those of the final product. Non limiting examples include thermoplastic polymers, crystallization accelerators or inhibitors, odor masking agents, cross linking agents, emulsifiers, salts, lubricants, surfactants, cyclodextrines, greasing agents, other optical brighteners, antioxidants, processing agents, flame retardants, dye stuffs, pigments, filler materials, proteins and their alkali salts, waxes, adhesive resins, extenders and mixtures thereof. These auxiliary agents are bound to the protein matrix and influence the properties of this one.

Salts can be added to the molten mass. Non limiting examples of salts include sodium chloride, potassium chloride, sodium sulfate, ammonium sulfate and mixtures thereof. Salts can influence the solubility of the protein in water, but also the mechanical properties. Salts can serve as binding agents between the protein molecules.

Lubricants can, on the other hand, influence the stability of the polymer. They can reduce the stickiness of the polymer and decrease the friction coefficient. Polyethylene is a non limiting example.

The physical properties of the polymer mass can be influenced by other proteins; these ones include, without limitation, for example vegetable proteins such as sunflower protein or animal proteins such as gelatine. Water soluble polysaccharides and water soluble synthetic polymers such as polyacrylic acids can also influence the mechanical properties.

Monoglycerides and diglycerides and phosphatides as well as other animal and vegetable fats can influence and favour the flow characteristics of the biopolymer.

Inorganic filler materials also belong to the optional additives and can be used as processing agents. Possible examples, which do not limit the use, are oxides, silicates, carbonates, lime, clay, limestone and kieselguhr and inorganic salts. Stearate based salts and colophony can be used for modifying the protein mixture.

Amino acids which are constituents of the proteins and peptides can be added to the polymer mass in order to enhance special pleated sheet structures or mechanical properties. Without limitation, glutamic acid, histidine, trytophane etc. are mentioned as examples.

Carbohydrates and polysaccharides as well as amyloses, oligosaccharides and chenodesoxycholic acids can be used as further auxiliary agents and additives.

Salts, carbonic acids, dicarbonic acids and carbonates as well as their anhydrides, salts and esters can also be used as additional cross linking agents. Hydroxides, butylesters as well as aliphatic hydrocarbons present other possibilities to cross link the molecules to each other and to form macromolecules.

The addition of other agents is not excluded. Additives and auxiliary agents, such as lipophile, hydrophobic, hydrophile, hydroscopic additions, glossing agents and crosslinking agents can be especially provided. The additives and auxiliary agents shall altogether not exceed a proportion of preferably about 30% by mass with regard to the protein. Vegetable oils, alcohols, fats can be chosen as lipophile additions which slightly hydrophobize the polymer mass already during the plasticizing operation. Furthermore, waxes and fats can be used which additionally give the polymer mass stability. Preferred waxes are carnauba wax, beeswax, candelilla wax and other naturally obtained waxes.

After the polymeric hydrogels have been formed, the milk protein gel can be further processed or the bound substance can be treated. A hydrophile or hydrophobic surface treatment can be added, in order to adjust the surface energy and the chemical condition of the substance. Hydrophobic milk protein gels or the polymeric hydrogel mass can be for example treated with wetting agents, in order to facilitate the absorption of aqueous liquids. A bound substance can also be treated with a topic solution which contains surfactants, pigments, lubricants, salt, enzymes or other materials, in order to further adjust the surface properties of the milk protein gel.

For achieving that the milk protein gels meet the stricter requirements by means of improved properties for a certain purpose, they are produced according to the production methods that have been known and described so far. The polymer mass is produced with the required viscosity by the continuous or discontinuous method which is known to the man skilled in the art and from literature, preferably by mixing or extruding a pre-mixture while adding additives or by preparing the polymer mass by dosing in the basic materials and additives during the mixing or extruding.

The production of milk protein gels can be realized according to known methods, for example by extrusion methods or by means of mixers, kneading devices or injection moulding machines.

The method in which water is used as solvent and plasticizer prevents any difficulties with respect to labour law, toxicology and product approval.

Thanks to the plasticizing operation, the polymer mass corresponds to a polymer in which the materials are transferred into a plastic state by heating them up and are deformed in this manner. Herein, the temperature exceeds the glass transition temperature of the protein such that this one is converted from the amorphous state into the rubber-like plastic state.

After the polymer mass has left for example the extruder, this mass can be immediately processed further, preferably for forming a hydrogel, by the extrusion method.

The polymer mass can be further processed to form a hydrogel either immediately after leaving the jet or in at least one later process step.

As a further development of the invention, the polymer mass can also pass through a bath before the hardening, wherein this process is not especially preferred and usually not required. Alternatively, the polymer mass can be subjected to a spraying treatment after having left the jet. Herein, for example smoothing agents, waxes, lipophiles or cross linking agents can be applied to the surface of the polymer mass. In the case of cross linking agents, the above mentioned ones are preferred: generally different salt solutions, preferably a calcium chloride solution, a dialdehyde starch solution or an aqueous lactic acid. Alternatively, the polymer mass can be subjected to a gas treatment or an ice treatment or a drying and blowing treatment or a ionic treatment or a UV treatment or an enzymatic treatment as well as to a renaturation by means of salts or esterification, etherification, saponification or another cross linking process as well as to a needling and hydro entangling process and to calendaring etc.

The hydrogels of the present invention which are composed of several constituents can be present in many different configurations. Constituent, such as used here, means, according to definition, the chemical substance or the material. Hydrogels can comprise mono component or multiple component configurations. Component, such as used here, is defined as a separate part of the milk protein gels which is in a spatial relationship with another part of the milk protein gel. The obtained milk protein gel can be again applied to a matrix.

The advantages obtained by the invention are inter alia that, in the production of hydrogels according to the invention, it becomes possible to reduce the substances which present a health risk and are environmentally harmful during the process and in the hydrogels themselves. Besides, the hydrogel is biodegradable.

Furthermore, considerable resources of energy, water, time and manpower can be saved, which enhances the environmental protection and improves the economic efficiency. The particularly advantageous properties of the milk protein gels are attributed to solidifying structural changes (tertiary structure) during the plasticizing operation.

The milk protein gels are preferably produced by an extrusion method in order to enable a highest possible productivity. All production methods of the described hydrogels, which are known to the man skilled in the art and from literature, can be used without any exception. It is essential with respect to the invention that a homogenously plasticized polymer, preferably a biogen biopolymer, can be produced that is biodegradable. Unfortunately, it has not been possible so far to develop hydrogels on this base which are water resistant and sufficiently resistant. Preferably, the use of petroleum-based raw materials and/or organic solvents, in particular for hydrogels which are used for wound dressing pads, childcare articles and cosmetics, just to mention a few examples, shall be reduced or even excluded.

For hydrogels which are preferably produced from renewable raw materials with a proportion of milk proteins and are characterized by features such as water resistance, sufficient mechanical properties such as tensile strength and tear resistance, and are antibacterial and biodegradable, it is furthermore possible to influence the properties of the milk protein gels according to the requirements of the intended purpose by changing the additions of raw materials.

The milk protein gels and their surface structures which are produced according to the method according to the invention can be used in numerous fields of application and be completely or partially composed of the surface structures; preferred examples without limiting effect are drug release devices which could be used for systematic, intratumoral, subcutaneous, topical, transdermal and rectal applications; wound dressings or artificial skin, solid moistened reaction media for diagnostic kits for being used in the basic research (PCR, RT-PCR, in situ hybridization, in situ marking with antibodies or other markers such as peptides, DNA or RNA probes, drugs or hormones etc.) etc.; transport media for cells, tissue, organs, eggs, organisms, etc: tissue culture media, with or without active substances, for the basic research or commercial and therapeutic applications; electrode materials (with or without enzymes); iontophoretic membranes; protecting moistened media for tissue sections (such as replacement cover slips for microscope slides); and matrices for the immobilization of enzymes or proteins for a in viva, in vitro or ex vivo use as therapeutic appliances, bioreactors or biosensors; cosmeceutical applications, such as skin hydration substances or moisturizers/humectants, as well as contact lenses, diapers and sanitary towels, water or exsudate absorbents in wound dressings, drug release, implants and coatings.

### EXAMPLES

In the following, the invention will be described in detail by means of an exemplary embodiment. The exemplary embodiment only serves to illustrating purposes and shall not limit the invention. On the base of this exemplary embodiment and his know-how, the man skilled in the art can find other possible embodiments by varying the parameters.

### Example 1

Production of a milk protein polymer mass. The extrusion is realized by a twin-screw extruder type 30 E of the company Dr. Collin having a diameter of 30 mm. The milk protein gel is produced by means of extrusion technology.

The heating is realized by four cylinder heating zones with the following temperature development: 65° C., 74° C., 75° C., 60° C.:

| | temperature | | | | | |
|---|---|---|---|---|---|---|
| | 65 | 74 | 74 | 74 | 75 | 60 |
| function | material | water | plasticizing | outlet zone | head | jet |
| | supply | supply | zone | | | |
| heating zone | I | II | II | II | III | IV |

The casein powder is supplied via a vibrating conveyor. Water is added by means of a peristaltic pump. The additives are added by means of other dosing devices. The polymer mass is processed to form a hydrogel by an extrusion method.

### BRIEF DESCRIPTION OF THE DRAWING

The drawing described herein is for illustrative purposes only of selected embodiments and not all possible implementations, and is not intended to limit the scope of the present disclosure.

### DETAILED DESCRIPTION OF THE PREFERRED EMBODIMENTS

Example embodiments will now be described more fully with reference to the accompanying drawing.

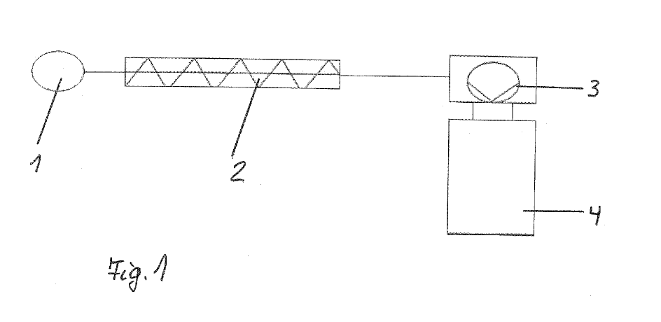

The course of the extrusion process, in which the polymer mass is processed to form a hydrogel, becomes additionally apparent in FIG. 1. The raw materials are dosed into the extruder 2 via a dosing device 1 and the polymer mass is mixed. From there, the polymer mass is supplied through a jet 3 to a post-treatment 4.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for the production of milk protein based gels, hydrogels, hydrocolloids and superabsorbers (milk protein gels) composed of a homogenous polymer on the base of proteins obtained from milk, which proteins are plasticized by addition of heat and a plasticizer.

2. A method according to claim 1, characterized in that the polymer material is output by means of an extruder.

3. A method according to claim 1 or 2, characterized in that the protein obtained from milk is either produced in situ by precipitation from milk or is used in form of a protein that has been separately obtained before and, if required, been prepared or in form of a protein fraction.

4. A method according to one of the preceding claims, characterized in that the proteins obtained from milk are obtained from bacteria.

5. A method according to one of the preceding claims, characterized in that the proteins obtained from milk are obtained by gas treatment or filtration.

6. A method according to one of the preceding claims, characterized in that the proteins obtained from milk are milk protein derivates.

7. A method according to one of the preceding claims, characterized in that the production method of the hydrogels or superabsorbers is carried out continuously.

8. A method according to one of the preceding claims, characterized in that the homogenous polymer that is composed of macromolecular gels and/or solutions is produced by means of a continuous or discontinuous process under mechanical stress, wherein the polymer material is preferably plasticized in a mixer, a kneading device, an injection moulding machine or an extruder.

9. A method according to one of the preceding claims, characterized in that the plasticizer is a constituent of the macromolecules.

10. A method according to one of the preceding claims, characterized in that the proteins obtained from milk, in particular casein, lactalbumin or soy protein are obtained from goat's milk, sheep's milk, cow's milk or soy milk.

11. A method according to one of the preceding claims, characterized in that the plasticizer is selected from the group: water, aqueous carbohydrate solution and in particular aqueous polysaccharides, proteins, alcohol, polyacohol, fats, acids, amino acid, peptides, salts, cations, enzymes or mixtures of these substances as well as their oxidation.

12. A method according to one of the preceding claims, characterized in that other additives and auxiliary agents are added to the base material to be plasticized, optionally by admixing before or during the plasticizing operation.

13. A method according to one of the preceding claims, characterized in that the milk protein gel is essentially water resistant, elastic, antibacterial and biodegradable and has tissue-like mechanical properties.

14. A method for producing milk protein gels according to one of the preceding claims, characterized in that at least one protein obtained from milk is plasticized together with a plasticizer under mechanical stress and preferably pressed through a jet.

15. A method according to one of the preceding claims, characterized in that the plasticizing is carried out at temperatures of up to 140° C.

16. A method according to one of the preceding claims, characterized in that the milk protein gel is dried and post-treated, in that it passes preferably through a bath, is subjected to a spraying treatment, a gas treatment, an ice treatment, a drying and blowing treatment, a ionic treatment, a UV treatment, an infrared treatment, an enzymatic treatment, a needling and hydro entangling process as well as to a renaturation by means of salts or alcohols, esters and ethers, esterification, saponification or etherification, to another cross linking or coating process, the calendering process etc.

17. A method according to one of the preceding claims, characterized in that the milk protein gel is destructured, oxidized or derivatized by means of chemical or enzymatic substances.

18. A method according to one of the preceding claims, characterized in that polymers and polysaccharides have fungicidal, antibacterial and antiviral properties and/or are considered to be natural remedies.

19. A method according to one of the preceding claims, characterized in that carboxylic acids, dicarboxylic acids and carboxylates as well as the salts and esters thereof, as well as aliphatic acids which are preferably biodegradable are used for the mixture.

20. A method according to one of the preceding claims, characterized in that aliphatic esters and aliphatic amide copolymers which are preferably biodegradable are used for the mixture.

21. A method according to one of the preceding claims, characterized in that the gel mass is destructured, oxidized, derivatized, etherified, esterified or saponified by means of chemical or enzymatic substances during or after the process.

22. A method according to one of the preceding claims, characterized in that amino acids are used for the mixture.

23. A method according to one of the preceding claims, characterized in that the milk protein gel is mixed with or post-treated by protease inhibitors, in particular enzymes, surfactants, acids, serpines, phenolic molecules from plants or polysaccharides.

24. A method according to one of the preceding claims, characterized in that the protein basic material is from any source, in particular animal, vegetable or microbial.

25. A milk protein gel comprising a thermally mechanically plasticized milk protein, in particular produced according to a method according to one of the claims 1 to 8.

26. A use of a milk protein gel according to claim 25 for the application to materials, without limitation, in particular textile surface structures, matrices and foils, e.g. woven materials such as tissues, knitted fabrics, knitted and crocheted fabrics or non-woven textiles such as felt and non-woven fabrics, but also as matrix itself or compound with other materials.
